(19) United States
(12) Patent Application Publication
(10) Pub. No.: US 2004/0176972 A1
(43) Pub. Date: Sep. 9, 2004

(54) System and method for processing information on goods or service

(76) Inventors: Kenji Baba, Kawasaki (JP); Chizuko Yasunobu, Tokyo (JP); Haruko Yakabe, Kawasaki (JP); Kiyoshi Kumagai, Tokyo (JP); Reki Yamamoto, Tokyo (JP)

Correspondence Address: MCDERMOTT WILL & EMERY LLP, 600 13TH STREET, N.W., WASHINGTON, DC, 20005-3096, US

(21) Appl. No.: 10/637,039

(22) Filed: Aug. 8, 2003

(30) Foreign Application Priority Data
Mar. 4, 2003 (JP) 2003-056515

(51) Int. Cl. G06F 17/60

(52) U.S. Cl. 705/1; 705/5; 705/35

(57) ABSTRACT

A service information processing system includes a goods information display unit for retrieving explanation and a price of goods and explanation of financial products and transmitting them to a client terminal; a goods determination judgment unit for retrieving a working term of the financial products from a contract information DB by using identification information of the financial products selected by the client, and starting monitoring whether or not the working term of the financial products is reached; and a good determination acceptance unit for retrieving one or a plurality of goods or services purchasable by a post-working amount obtained as a result of investment of a fund corresponding to the purchase amount in the selection financial products when the working term is reached.

### BACKGROUND OF THE INVENTION

This invention relates to a system and a method for processing information on goods or services.

JP-A-2003-30287 as one of the related technologies discloses a touring agent assistance system that enables a client to pursue each database provided to a server through a client terminal, to acquire information on tourist resorts, accommodations and optional tours, to customize a tour by selecting an accommodation and an optional tour on the basis of a base tour recorded on the server as a reference and to work out an original tour satisfying the client's requirement.

JP-A-2002-133165 discloses a tour intermediation guidance system wherein a management server includes a classification/recording unit for classifying desired tour-acquisition information sent from tour agent terminals and recording them in database, an analysis/collation unit for analyzing inquiry information sent from client terminals, collating such inquiry with desired tour-acquisition information stored in the database and extracting a corresponding tour agent, and an information reporting unit for sending the inquiry information to the agent terminal extracted by the analysis/collation unit. When the inquiry information for desired conditions of the client is sent from the client terminal, the management server reports inquiry information to a terminal of a tour agent desiring the information of the field to which the inquiry information belongs so that the client can acquire the tour plan satisfying the condition from the tour agent by merely reporting the desired condition.

However, the related technologies described above do not at all consider linking of a tour and financial products.

### SUMMARY OF THE INVENTION

It is an object of the invention to provide a system and method that can enlarge freedom of selection of goods or services by clients by providing goods or services of a novel form to the clients.

It is another object of the invention to provide a method and system that can increase the number of transactions of financial products and can activate a financial products market.

It is another object of the invention to provide a system and method that can handle together an effect of a price change of financial products and purchase of goods.

It is still another object of the invention to provide a method and system that enables a client to frequently visit a site to confirm a rise/drop of a goods grade due to a price change of financial products even after the client decides to purchase a goods.

According to the invention, a service provision server having both goods information of goods provision companies and financial products information of securities companies is set up on a network. The service provision server enables a client to select financial products, too, when the client purchases goods. However, the service provision server may determine in advance financial products for each goods. A plurality of grades is set to goods in the goods provided by the goods provision companies to constitute a goods group containing those goods that have mutually different prices. Therefore, the client can acquire the goods of a higher grade when the price of the financial products rises and the goods of a lower grade when the price of the financial products drops. A company operating the service provision server pays the amount corresponding to the goods the client finally decides to purchase to the goods provider. Incidentally, a service may replace the goods in the description given above.

The invention can provide goods or services of a novel form in which the grade changes in accordance with the price change of the financial products, and can enlarge selection freedom of goods or services by the client.

Because the invention invests the purchase fund of the goods or service in the financial products, it can increase the number of transactions of the financial products and can active the financial products market.

The invention can eliminate the problem of the related technologies described above and can enjoy the price change of the financial products while purchasing ordinary goods. From the viewpoint of the goods providers, the contact with the client increases because the client visits the site to watch a working status confirmation screen even after the purchase procedure of the goods is completed.

Other objects, features and advantages of the invention will become apparent from the following description of the embodiments of the invention taken in conjunction with the accompanying drawings.

### BRIEF DESCRIPTION OF THE DRAWINGS

FIG. 1 is a structural view showing a system according to an embodiment of the invention;

FIG. 2 is a flowchart showing an overall processing in the embodiment of the invention;

FIG. 3 is a table storing goods information in the embodiment of the invention;

FIG. 4 is a table storing goods information in the embodiment of the invention;

FIG. 5 is a table storing financial products information in the embodiment of the invention;

FIG. 6 is a table storing market price information of financial products in the embodiment of the invention;

FIG. 7 is a flowchart showing a goods entry processing in the embodiment of the invention;

FIG. 8 is a flowchart showing a goods entry screen in the embodiment of the invention;

FIG. 9 is a table storing goods entry information in the embodiment of the invention;

FIG. 10 is a flowchart showing a financial products selection processing in the embodiment of the invention;

FIG. 11 is a financial products selection screen in the embodiment of the invention;

FIG. 12 is a flowchart showing a working status confirmation processing in the embodiment of the invention;

FIG. 13 is a working status confirmation screen in the embodiment of the invention;

FIG. 14 is a table for judging a working term in the embodiment of the invention;

FIG. 15 is a table for judging a working upper limit in the embodiment of the invention;

FIG. 16 is a table for judging a working lower limit in the embodiment of the invention;

FIG. 17 is a table storing goods entry information in the embodiment of the invention; and

FIG. 18 is a flowchart of a goods determination processing in the embodiment of the invention.

### DETAILED DESCRIPTION OF THE EMBODIMENTS

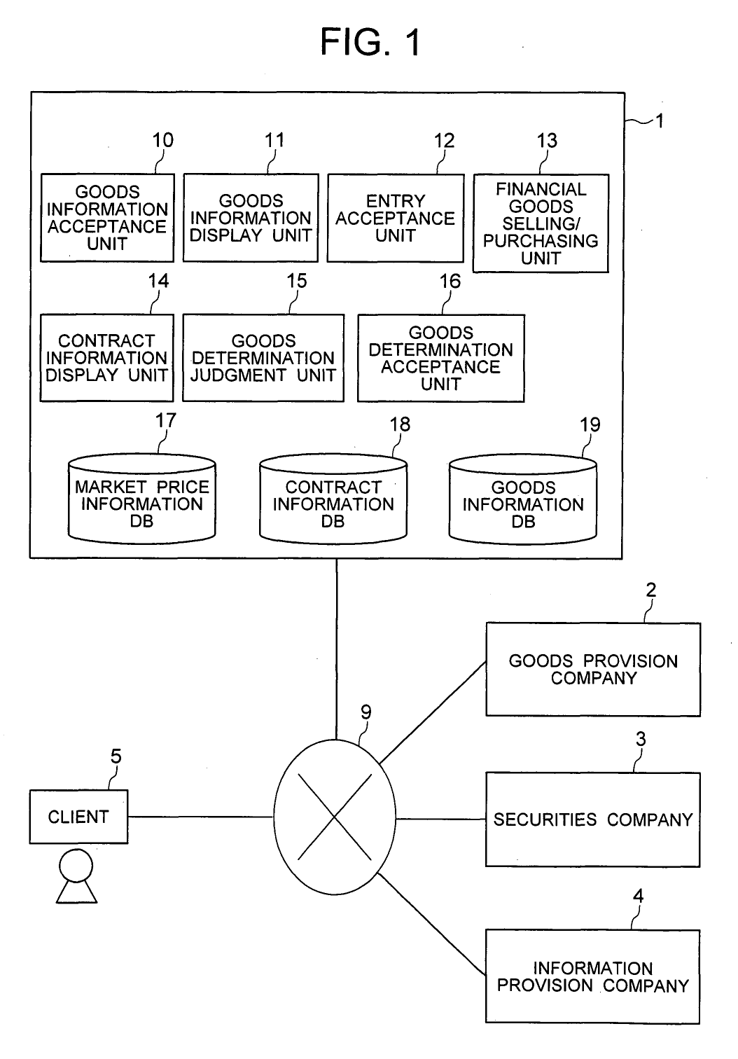

An overall structural view of a system shown in FIG. 1 will be explained.

In this embodiment, a service provision server 1 capable of extracting goods to be offered to clients from a goods group containing a plurality of goods having mutually different prices, a goods provision company system 2 capable of providing explanation of goods and their prices, a securities company system 3 for selling or purchasing financial products, an information provision company system 4 capable of providing explanation of financial products and their market prices and a client terminal 5 used by each client for purchasing the goods are connected to one another through a communication network 9. Here, the number of each constituent factor connected to the communication network 9 such as the service provision server 1, the client terminal 5 and each company system 2 to 4 is only one, but a plurality of these constituent factors may be connected, too. The communication network 9 may LAN, the Internet or other arbitrary wired or wireless networks. Services may be provided to the clients in place of the goods. Each of the service provision server 1, the company systems 2 to 4 and the client terminal 5 includes a CPU for processing, a storage device for storing data and programs (RAM, ROM, hard disk and the like, for example), and a communication unit for communicating with an external unit through the network 9. The term “goods” means those that exclude “financial products”. The goods include real estate. The term “financial products” represents stocks, bonds, investment trusts, derivatives, exchanges, real estate investment trusts, and so forth.

The construction of the service provision server 1 will be hereinafter explained.

A goods information acceptance part 10 has the function of accepting goods information from the goods provision company system 2 and financial products information from the securities company system 3 and storing them in a goods information DB 19 and the function of accepting provision of market price information of the financial products from the information provision company system 4 and storing the information in a market price information DB 17.

A goods information display part 11 generates and displays a screen for the client terminal 5 on the basis of the information accepted by the goods information acceptance part 10. In other words, the goods information display part 11 creates a screen construction file for allowing the client terminal 5 to display a predetermined screen and transmits the screen construction file 5 to the client terminal 5.

An entry acceptance part 12 accepts an entry of a client from the client terminal 5 and stores the entry content accepted in contract information DB 18.

A financial products selling/purchasing part 13 gives a selling/purchasing instruction of financial products to the securities company system 3. When a goods purchase order is given from the client terminal, the financial products selling/purchasing part 13 gives a purchase instruction of the financial products to the securities company system 3. When working of the financial products is completed, the financial products selling/purchasing part 13 gives a selling instruction of the financial products to the securities company system 3. However, the financial products selling/purchasing part 13 may only display a working end notice of the financial products without giving the selling/purchasing instruction to the securities company system 3. In this case, a user of the service provision server 1 gives the selling/purchasing instruction of the financial products to a securities company.

A contract information display part 14 extracts contract information of a client from the contract information DB 18 and displays it on the client terminal 5 upon request from the client terminal 5.

A goods determination judgment part 15 judges whether or not the goods is to be determined at the present time from the date and the market price information of the financial products.

A goods determination acceptance part 16 accepts the judgment of the goods determination judgment part 16 that the goods is to be now determined, and executes a determination processing of the goods.

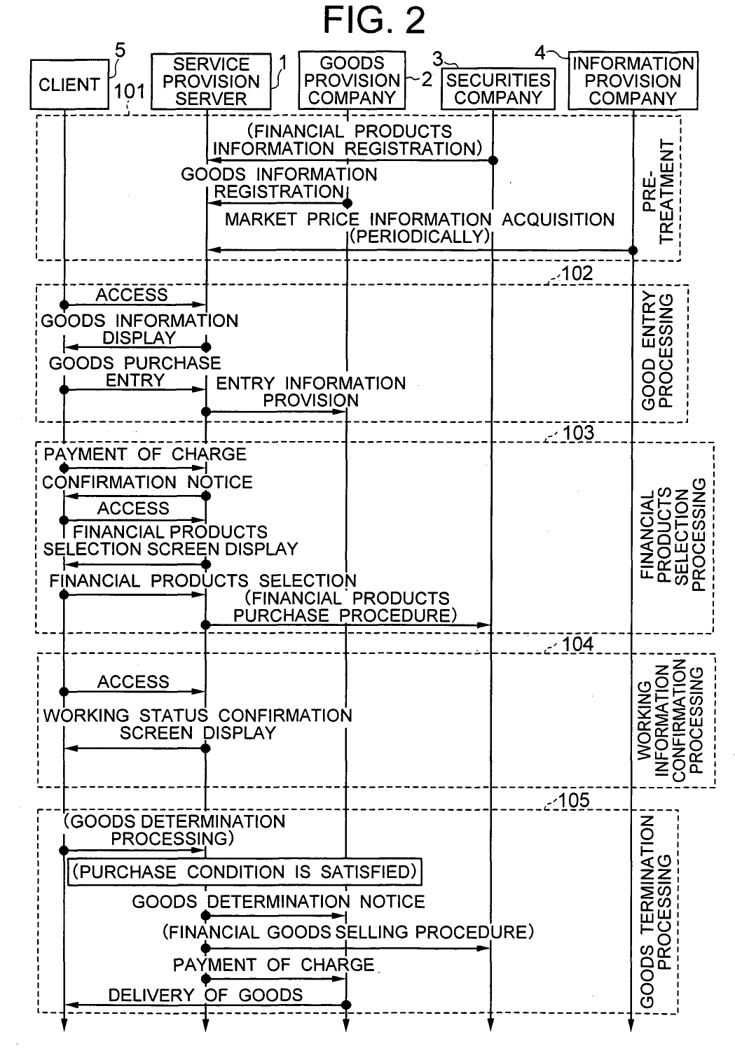

Next, an outline of a processing procedure in this embodiment will be explained with reference to FIG. 2. A CPU executes the following processing in accordance with a program. FIG. 2 describes in a time sequence the processing executed between parties concerned, that is, the service provision server 1, the goods provision company system 2, the securities system 3, the information provision company system 4 and the client terminal 5. To have the explanation more easily understood, the processing is grouped into five groups and each group is encompassed by a dotted line. These groups are called “prior processing” (processing 101), “goods entry processing” (processing 102), “financial products selection processing” (processing 103), “working information confirmation processing” (processing 104) and “goods determination processing” (processing 105), respectively.

First, when the prior processing (processing 101) is executed, the service provision server 1 requests provision of the goods information to the goods provision company system 2, provision of the financial products information to the securities company system 3 and the market prices of the financial products to the information provision company system 4, acquires the goods information, the financial products information and the market price information from the respective systems 2 to 4 and stores them in the goods information DB 10 and in the market price information DB 17. The goods provision company system 2 provides information of goods to be sold on the service provision server 1. The securities company system 3 provides information of the financial products (inclusive of explanation of the financial products) to be selected by clients on the service provision server 1. Preferably, the service provision server 1 requests periodically, e.g. once a day, the market prices of the financial products to the information provision company system 4, receives the market prices of the financial products from the information provision company system 4 and stores one after another the information in the market price information DB 17.

Assuming hereby that the goods provision company is a travel company, goods information of a package tour includes a tour name, explanation of the tour and its price, for example. A plurality of grades is available for one goods, and each grade has a different price. One goods of “Six Days in Hawaii”, for example, is graded into five grades of A, B, C, D and E depending on the rank of hotels, and they have mutually different prices.

Information of the financial products includes a name of financial products, its explanation and its code. A company operating the service provision server 1 may examine by itself the information of the financial products without acquiring it from the securities company system 3 and the user of the service provision server 1 may input the information.

The market price information of the financial products includes information that associates the code of each financial products, its name and its market price, for example.

Next, the service provision server 1 accepts the goods purchase entry from the client terminal 5 through the goods entry processing (processing 102) and transmits the entry information to the goods provision company system 2. More concretely, when the client terminal 5 gains access to the service provision server 1, the service provision server 1 reads out the goods information from the goods information DB 19 on the basis of the information acquired by the prior processing (processing 101) and transmits the goods information to the client terminal 5. The client terminal 5 displays the entry screen inclusive of the goods information. A plurality of grades having different prices is set to the goods information displayed by the client terminal 5, and the content of the goods for each grade is different. The client terminal 5 receives selection of one or a plurality of goods information the client wants to purchase from among goods information to which a plurality of grades is set, and further receives designation of personal information and a settlement method. The client terminal 5 then transmits one or a plurality of goods information selected by the client, personal information and the settlement method to the service provision server 1. The service provision server 1 receives the goods information selected by the client, personal information and the settlement method, stores them in the contract information DB and transmits these information to the goods provision company system 2. The service provision server 1 may receive from the client terminal 5 the purchase entry of the client for the overall goods information to which a plurality of grades is set instead of receiving one or a plurality of goods information the client enters the purchase from among the goods information to which a plurality of grades is set. In other words, the client selects a plurality of goods having different grades as a whole instead of selecting the individual grades.

Next, the processing shifts to the financial good selection processing (processing 103). Receiving the payment notice of the client from the client terminal 5, the service provision server 1 transmits a payment confirmation notice to the client terminal 5. Receiving the confirmation notice, the client terminal 5 gains access to the service provision server 1 in accordance with the instruction of the client. The service provision server 1 reads out one or a plurality of financial products information selectable for the goods information selected by the client from the goods information DB and transmits this financial products selection screen to the client terminal 5. The client terminal 5 displays the financial products selection screen inclusive of one or a plurality of financial products information and accepts the selection of the financial products from the client. Here, the grade of the goods the client acquires changes with the price change of the selected financial products. In other words, when the client purchases a package tour in which the hotel rank moves up and down, a hotel having a higher rank is provided when the price of the selected financial products moves up and a hotel having a lower rank is provided when the price moves down. The working term of the fund is determined by a tour condition such as the departure date of the tour. The service provision server 1 subtracts a predetermined period such as a period required from the contract date of selling of the financial products to the conversion of the goods into the money and a cancel acceptance period of the hotel from the goods provision date (delivery date) and decides the working term of the financial products. This predetermined period is stored for each goods in the goods information DB 19. The service provision server 1 may receive the change (shortening of the working term) of the working term within the range of the working term of the financial products from the client through the client terminal 5. When the client selects a plurality of desired hotel tanks, the upper and lower limit prices of working the fund are determined. When the client selects a plurality of goods having different grades as a whole instead of selecting an individual goods, it is preferred that the upper limit price of working is calculated from the price of the highest grade among a plurality of goods having different grades, and the lower limit price of working is calculated from the price of the lowest grade.

The company operating the service provision server 1 may select the financial products in place of the client. In this case, the goods information DB 19 stores one financial products determined for each goods. When the client places the purchase order of the goods through the client terminal 5, the service provision server 1 retrieves the financial products from the goods information B 19 by using the goods information as the key and decides the financial products as the financial products to which the goods purchase fund is invested.

The company operating the service provision server 1 pays the payment of the goods to the goods provision company in accordance with the price change of the financial products and provides the goods to the client in exchange for the payment of the goods so made. Therefore, the company operating the service provision server 1 takes the risk that it must pay a greater amount of money when the price of the financial products selected by the client rises. To avoid this risk, the service provision server 1 can place as such the purchase order of the financial products selected by the client to the securities company system 3. Because the selling procedure of the financial products becomes necessary in the post-processing, it will be efficient if the balance of purchasing and selling for a day is collectively purchased or sold. In other words, the company operating the service provision server 1 in the invention may actually purchase the financial products or need not purchase them.

The working information confirmation processing (processing 104) is the one that confirms the present status for the information the client has already applied. Because the price of the financial good selected by the client changes daily, this processing has the function of grasping the present status. More concretely, when the client 5 gains access to the service provision server 1, the service provision server 1 identifies the client making the access and displays the present information of the client on the screen from the contract information it manages and from the market price information of the financial products.

When the market price of the financial products is sufficiently high or when the client feels that this market price will drop in future, the client can determine at any time the goods grade on the screen through the client terminal 5.

The goods determination processing (processing 105) is a processing for finally determining the grade of the goods and covering the procedure until the client acquires the goods. To determine the grade of the goods, any of the following conditions (1) to (4) must be satisfied. (1) The client determines the grade in the working information confirmation processing (processing 104). (2) The working term set at the time of entry arrives. (3) The working price reaches the upper limit price set at the time of entry. (4) The working price reaches the lower limit price set at the time of entry. When any of these conditions is satisfied, the service provision server 1 notifies the goods so determined to the goods provision company and executes the procedure of paying the charge. However, when the market price of the financial products is below the working lower limit price, the client cannot purchase the goods. Therefore, the working lower limit value is preferably secured. When the market price of the financial products exceeds the working upper limit value, however, no problem occurs for the client, and the working upper limit price need not be secured. Receiving the payment of the charge, the goods provision company provides the goods of the corresponding grade to the client. When the company operating the service provision server 1 purchases the financial products in the financial products selection processing (processing 103), the company sells hereby the financial products.

When the price after working exceeds the price of the goods so determined and the fund becomes excess, the surplus may be returned by cash or electronic money. The company operating the service provision server 1 may return the surplus as the points that can be utilized in the goods provision company or as a merchandise coupon. The service provision server 1 may notify the client terminal 5 of the amount of the surplus.

The embodiment of the invention will be explained in further detail with reference to flowcharts and tables. First, the prior processing (processing 101) will be explained.

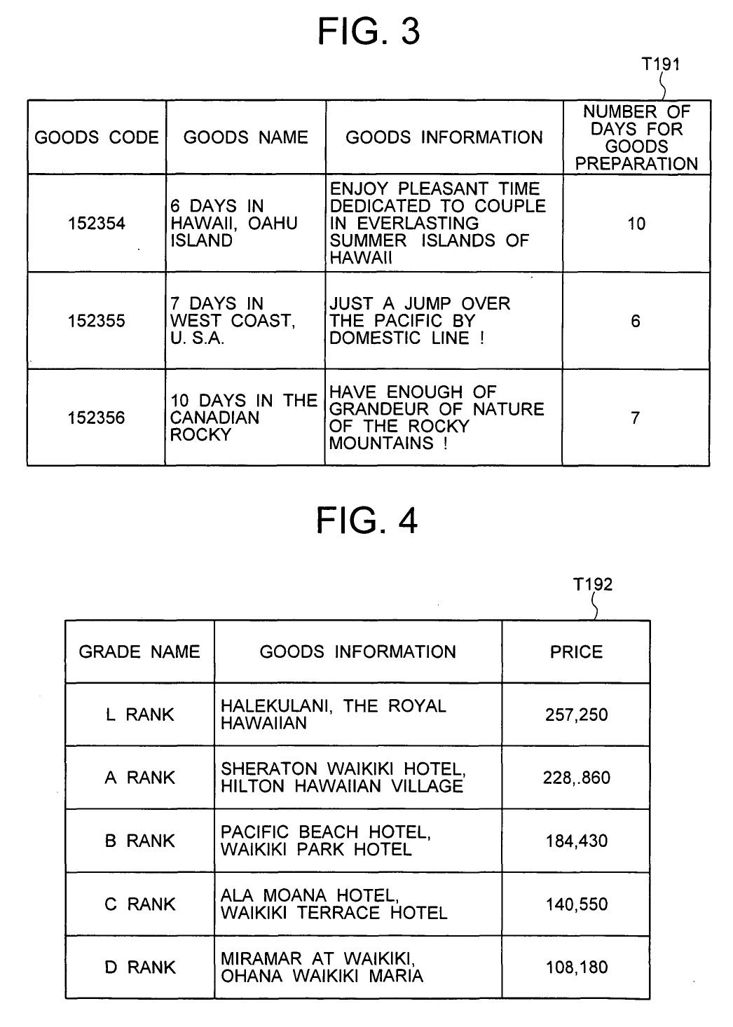

The goods provision company system 2 transmits a goods table T191 shown in FIG. 3 and information tabulated in a goods sub-table T192 shown in FIG. 4 to the goods information acceptance part 10.

It will be assumed hereby that a goods code in the goods table T191 comprises a combination of a number uniquely allocated to a goods provider of the goods provision company system 2, for identifying the goods provider and a goods number allocated by the goods provider by itself, and that a unique number is allocated to each of all the goods. The number of goods preparation days means the number of days from the date on which the grades of the goods to be finally sold to the clients are determined to the date on which the client can actually utilize the goods. In the case of the package tour goods in which the grade of the hotels changes, the number of goods preparation days represents the number of days of allowance before the departure date for the client to determine the grade of the hotel in order to acquire the goods. One row of the goods table T191 represents one goods.

The goods sub-table T192 describes information for grading each goods tabulated in the goods table T191. More concretely, the goods sub-table T192 describes a grade name, explanation of goods and a price for each grade. One goods sub-table is associated with one goods in the goods table. The goods sub-table T192 describes information of the grade of the goods of the first row of the good table T191. The goods provider 2 prepares the goods sub-tables for all the goods tabulated in the goods table T191 and provides them to the goods information acceptance part 10, but its explanation will be hereby omitted.

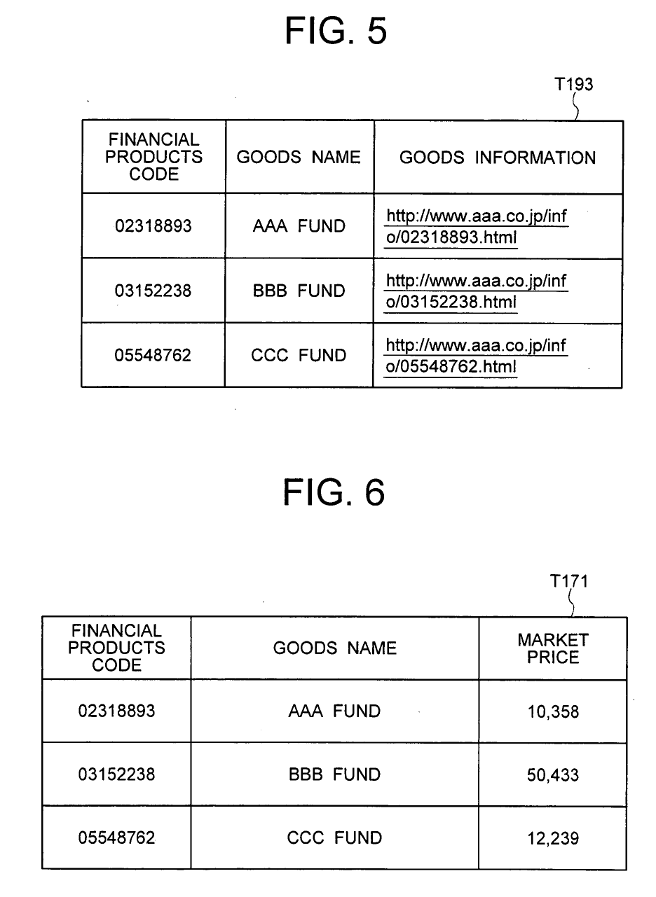

The securities company system 3 transmits information tabulated in financial products table T193 shown in FIG. 5 to the goods acceptance part 10.

A financial products code in the financial products table T193 is the one that a third party, or the like, allocates uniquely to each financial products. It can acquire the market price of each financial products by use of the information provided by the information provision company. The financial products table T193 wholly represents information of the investment trust. An eight-digit code that is utilized ordinarily exists in the investment trust, and the table T193 describes this code. If a suitable code does not exists as the financial products code, the service provision server 1 must allocate a peculiar code by itself and must grasp the price. The goods information may be information itself or a site of the information such as URL.

The goods provision company system 4 transmits information such as the one shown in a market price information table T171 in FIG. 6 to the goods information acceptance part 10. The market price represents the price of each financial products at that moment. The goods provision company system 4 may transmit the market price to the goods information acceptance part 10 in response to the request from the goods information acceptance part 10.

The goods information acceptance part 10 stores the information tabulated in the goods table T191, the goods sub-table T192 and the financial products table T193 in the goods information DB 19 and the information tabulated in the market price information table T171 in the market price information DB 17.

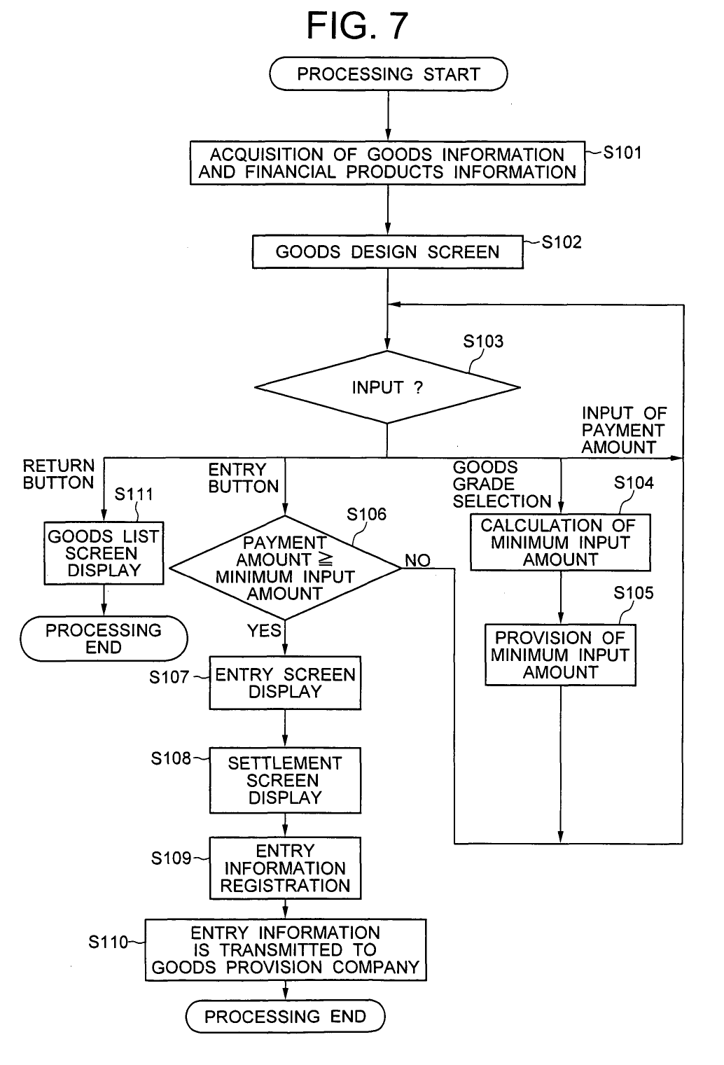

Next, a goods entry processing (processing 102) will be explained with reference to a flowchart shown in FIG. 7. When the client gains access to the service provision server 1 through the client terminal 5, the goods information display part 11 acquires the goods information T191 from the goods information DB 19 and submits a goods list screen including a plurality of goods information having different grades through the client terminal 5. The client selects a desired goods from among the goods submitted while confirming the vacancy condition with reference to the departure date, the number of participants, etc in the same way as the entry procedure at an ordinary site for ordering a travel.

The flowchart shown in FIG. 7 shows the processing that the goods information display part 11 and the entry acceptance part 12 execute after the client selects the desired goods.

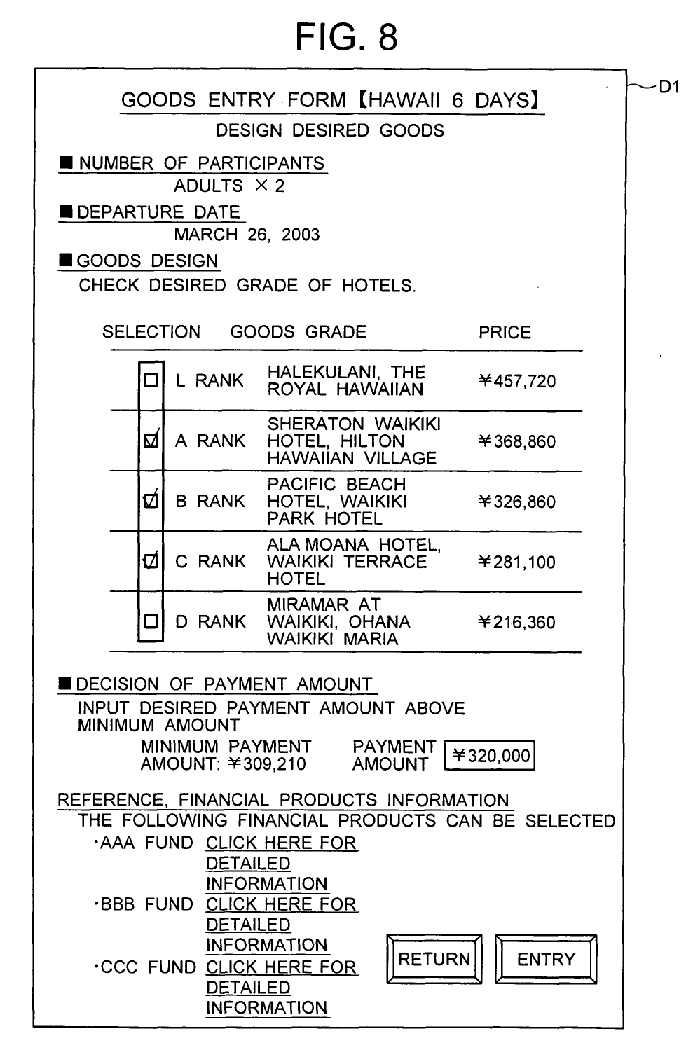

The goods information display part 11 receives goods selection from the client through the client terminal 5. The goods information display part 11 acquires the goods table T192 of the corresponding goods from the goods information DB 19 (Step S101). The goods information display part 11 creates the goods entry screen D1 shown in FIG. 8 by use of the information so acquired and the input information of the client. In this goods entry screen D1, the client can decide the grade of the desired goods for purchase and the amount to be paid through the client terminal 5. The grade of the goods reflects the information of the goods sub-table T192 and a plurality of hotel ranks can be selected from five ranks of L, A, B, C and D. When the client checks the grade of the goods through the client terminal 5, the goods information display part 11 judges the lowest grade among those that are checked at present, and derives its amount. An amount of a predetermined ratio (10%, for example) is added to this amount to give the lowest payment amount (Step S104). Here, the numerical value of 10% is a margin that is secured for preventing the price from becoming below the lowest desired rank due to the drop of the market price of the financial products. The numerical value may be a value other than 10%, but it will be assumed hereby that the value is in advance decided as 10%. When the lowest grade is the C rank as shown in the goods entry screen D1, the lowest payment amount is calculated as ¥309,210 as the sum of ¥281,110 plus 10% (Step S104). This value is displayed for the client through the client terminal 5 (Step S105). Whenever the check of the grade of the goods is added/omitted/changed, the goods information display part 11 repeats Step S104 and Step S105.

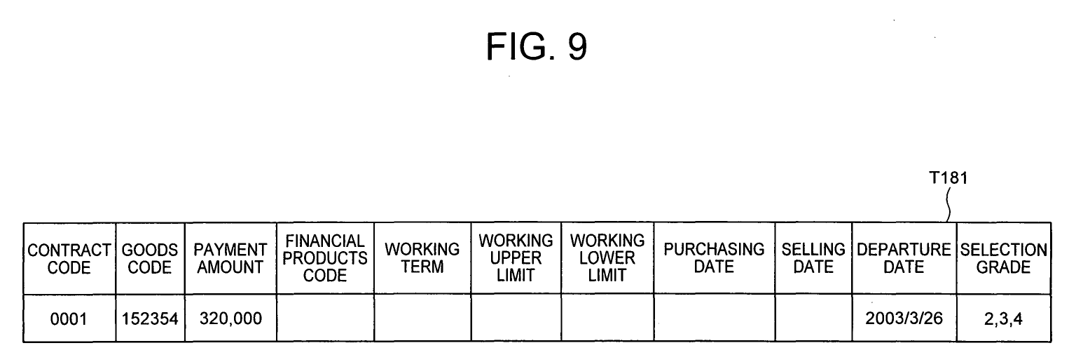

When the client pushes down the entry button of the client terminal 5, the client terminal 5 transmits the entry information to the goods information display part 11. The goods information display part 11 confirms whether or not the amount described in the payment amount column is greater than the lowest payment amount. When the goods information display part 11 confirms that the payment amount is greater than the lowest payment amount, the entry acceptance part 12 transmits the entry screen in which the client inputs personal information, etc (Step S107) and a settlement screen in which the client inputs a settlement method (Step S108), then receives the personal information and the settlement method from the client terminal 5 and finishes the entry. The entry acceptance part 12 stores the information thus entered in the contract information DB 18 in the form of the table T181 shown in FIG. 9 (Step S109). The information so entered is transmitted to the goods provision company for reference (Step S110). When the client pushes down a return button in the client terminal 5, the screen returns to the goods list screen (Step S111).

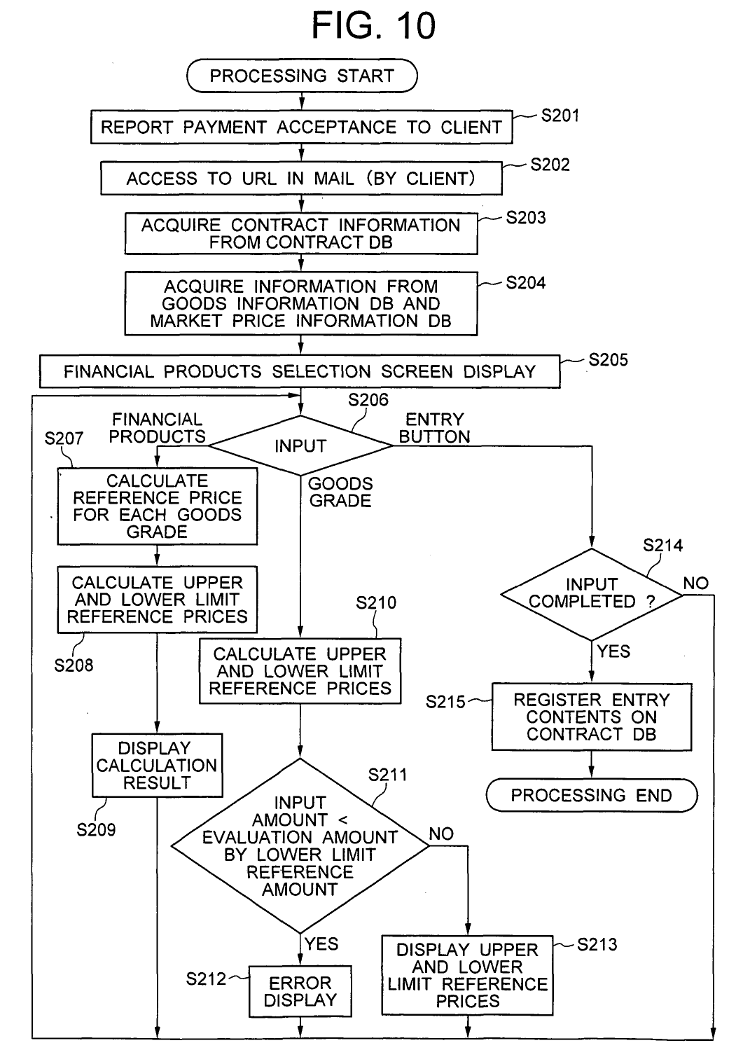

Next, the financial products selection processing (processing 103) will be explained with reference to a flowchart shown in FIG. 10. The client makes payment to the company operating the service provision server 1 in accordance with the payment amount and the settlement method designated in the goods entry processing (processing 102). The flowchart in FIG. 10 shows the processing that the entry acceptance part 12 executes after the company operating the service provision server 1 receives the payment from the client.

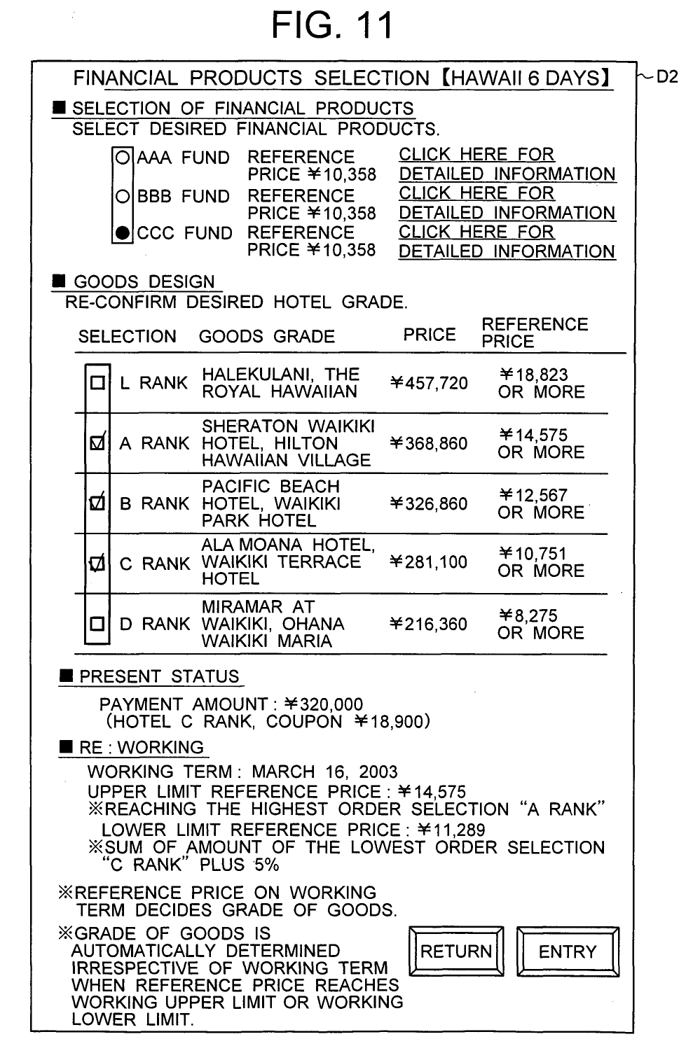

First, the entry acceptance part 12 notifies the client of the receipt of the payment through the client terminal 5 (Step S201). Here, a mail is transmitted. A link to the entry acceptance part 12, to which the information corresponding to the entry information of the client is added, is put into the mail. When the client traces this link through the client terminal 5 (Step S202), the entry acceptance part 12 acquires the entry information T181 shown in FIG. 9 from the contract information DB 18, the goods table T191 and the financial good table T193 from the goods information DB 19 and the market price information table T171 from the market information DB 17 (Steps S203 and S204), creates a financial products selection screen D2 shown in FIG. 11 and displays the financial products selection screen D2 on the client terminal 5. Here, the market price of the financial products is acquired from the financial good table T193 and from the market price information table T171 by associating the financial products code. The working term proves Mar. 16, 2003 when Mar. 26, 2003 as the departure date stored in the entry information T181 is went back by 10 days as the number of the goods preparation days stored in the goods table T191. The number of the goods preparation days may be the number of business days but the simple number is hereby used.

The entry acceptance part 12 receives selection of the financial products from the client through the client terminal 5 and then calculates a reference price for each goods grade (Step S207). Assuming that a CCC fund is selected, calculation is made as to the rise or drop of which yen (¥) brings the reference price that is ¥12,239 at present to the price of each rank. In this case, a sales tax is taken into consideration, too. More concretely, the entry acceptance part 12 looks up the goods sub-table T192, calculates the balance between the payment amount and the price of each goods selected by the client and adds the balance and the tax to the reference price. The sum of the reference price, the balance and the tax is the minimum reference price that can purchase the goods of each grade.

The upper limit reference price calculates the reference price reaching the price corresponding to the A rank as the highest grade among the selected grades. As to the lower limit reference price, a reference price that reaches the sum obtained by adding a predetermined ratio (5%, for example) to the price corresponding to the C rank as the lowest grade among the selected grades is calculated (Step S208). Here, the value 5% is a margin so set as to mitigate the risk that the market price becomes further lower than the minimum rank as a result of working. This value may be other than 5%. Here, the explanation will be given on the premise that the numerical value is in advance set to 5%. Subsequently, the calculation results in Steps S207 and S208 are displayed on the screen.

When the client selects the goods grade or fails to select the grade, the entry acceptance part 12 calculates the upper limit reference price and the lower limit reference price in the same way as in Step S208 (Step S210). Whenever the check of the grade is added/omitted/changed, the goods information display part 11 repeats Step S201. Next, the entry acceptance part 12 compares the evaluation value when the lower limit price is reached, that is, the price as the sum of the price corresponding to the lowest rank set plus 5%, with the payment amount (Step S211). When the payment amount is smaller, the entry acceptance part 12 displays an error display to the effect that such setting of the goods grade is not possible, on the client terminal 5 (Step S212). The entry acceptance part 12 displays at other times the upper limit reference price and the lower limit reference price that have already been calculated, on the client terminal 5 (Step S213).

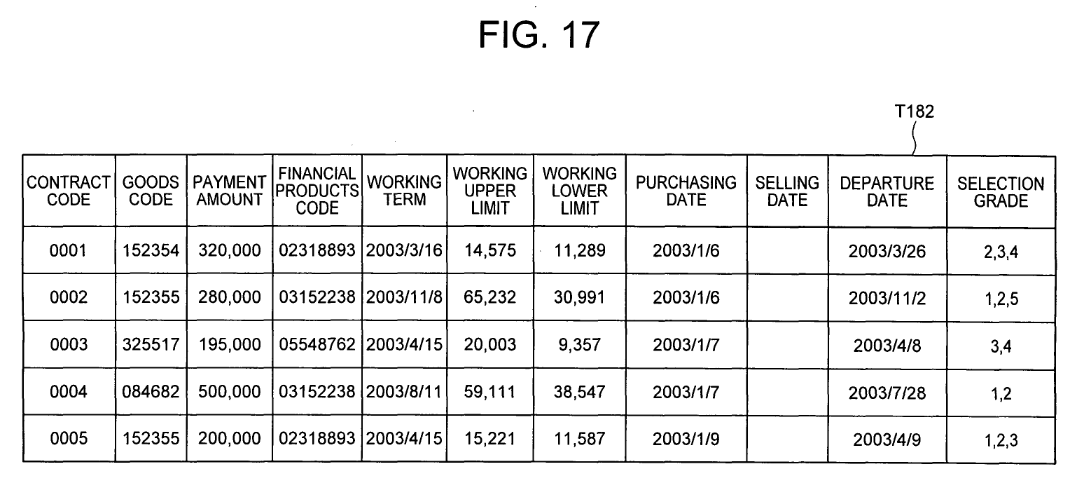

When the client pushes down the entry button of the client terminal 5, the entry acceptance part 12 confirms whether not all the necessary information is inputted (Step S214). When all the necessary information is inputted, the entry acceptance part 12 registers the entry content of the input information to the contract information DB 18 (Step S215) and finishes its processing. The input information is registered to the contract information DB 18 in the form of the record of a contract code 0001 in the table T182 shown in FIG. 17.

As a result of the procedure described above, the grade of the hotel in the package tour of “Six Days in Hawaii” is any of the A, B and C ranks due to the price change of the CCC fund. Here, the company operating the service provision server 1 pays the amount of the money corresponding to the amount at the end of working of the CCC fund to the goods provider 2. The company operating the service provision server 1 can acquire the information that the paid amount of ¥320,000 is invested in and worked by the CCC fund on the basis of the information of the contract information table T182. The company operating the service provision server 1 can avoid the risk of the price change by purchasing as such the financial products selected by the client.

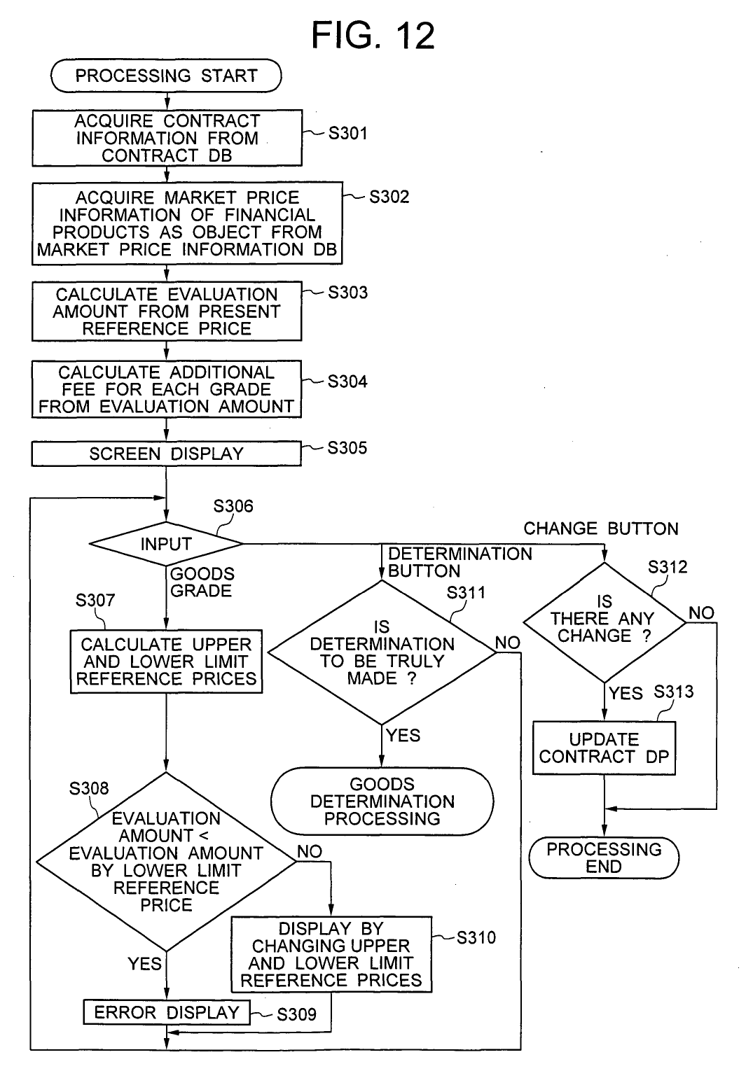

Next, the working information confirmation processing (processing 104) will be explained with reference to the flowchart shown in FIG. 12.

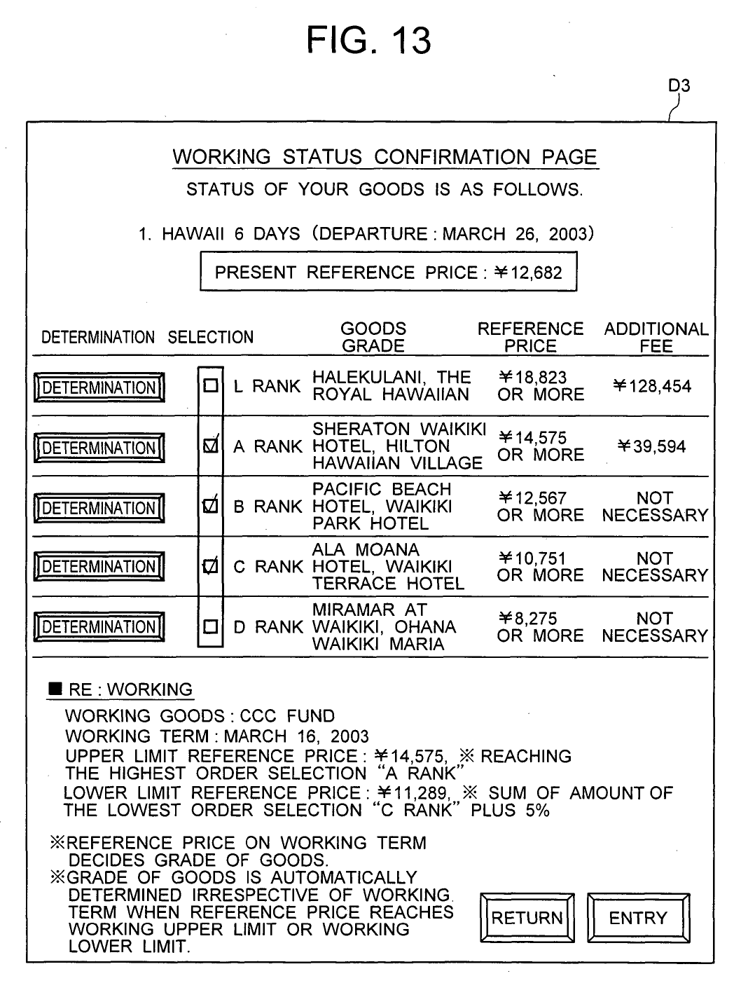

When the client makes a perusal request about the contract information of its own to the contract information display part 14 through the client terminal 5, the contract information display part 14 first acquires the contract information from the contract information DB 18 (Step S301) and then acquires the market price information of the financial products as the contract object from the market price information DB 17 (Step S302). Next, the contract information display part 14 calculates the present evaluation amount of the amount paid first from the present reference price of the financial products (Step S303) and calculates the additional amount for each grade (Step S304). More concretely, the contract information display part 14 looks up the goods sub-table T192 and calculates the balance between the sum of the evaluation amount plus the tax and the price of each goods selected by the client. This difference is the additional amount. Here, the term “additional amount” means the amount of money additionally necessary for getting goods of a higher grade that cannot be selected at the present evaluation amount. When the client pays the additional amount put to each grade, the client can acquire the goods of that grade. Next, the calculation results of Steps S303 and S304 are displayed on the screen. The screen is like the working status confirmation screen D3 shown in FIG. 13.

The client can not only confirm the present working status but can also determine the final grade on this screen D3. In the working status confirmation screen D3, the additional amount is not necessary for the B, C and D ranks. An additional amount of ¥128,454 is necessary to determine the hotel of the L rank. The client can select the L rank hotel by paying the additional amount described above though the L lank is not selected originally as the option. The difference between the case where the L rank is selected and the case where it is not is the difference of the upper limit reference price. When the L rank is not selected, working is automatically stopped when the reference price rises to a level at which the A rank below the L rank can be determined. When the L rank is selected, on the other hand, working is as such continued.

When the goods grade is set again in the operation confirmation screen D3, the upper reference price and the lower reference price are calculated (Step S307) in the same way as when the goods grade is set again in the financial products selection process (processing 103). When the evaluation amount by the market prices of the CCC fund is lower than the evaluation amount by the lower limit reference price, an error to the effect that such selection cannot be made is displayed (Step S309). Otherwise, the upper limit reference price and the lower limit reference amount that have already been calculated are displayed.

When the client pushes down the change button through the client terminal 5, the contract information display part 18 confirms whether or not any change exists in the content of the screen (Step S312), updates the contract information DB 18 if any exchange exists (Step S313) and finishes as such the processing if no change exists.

When the client pushes down the determination button of each grade through the client terminal 5, the goods determination judgment part 15 confirms whether or not that grade may well be determined through the client terminal 5 (Step S311) and when approved, the processing moves to the goods determination processing.

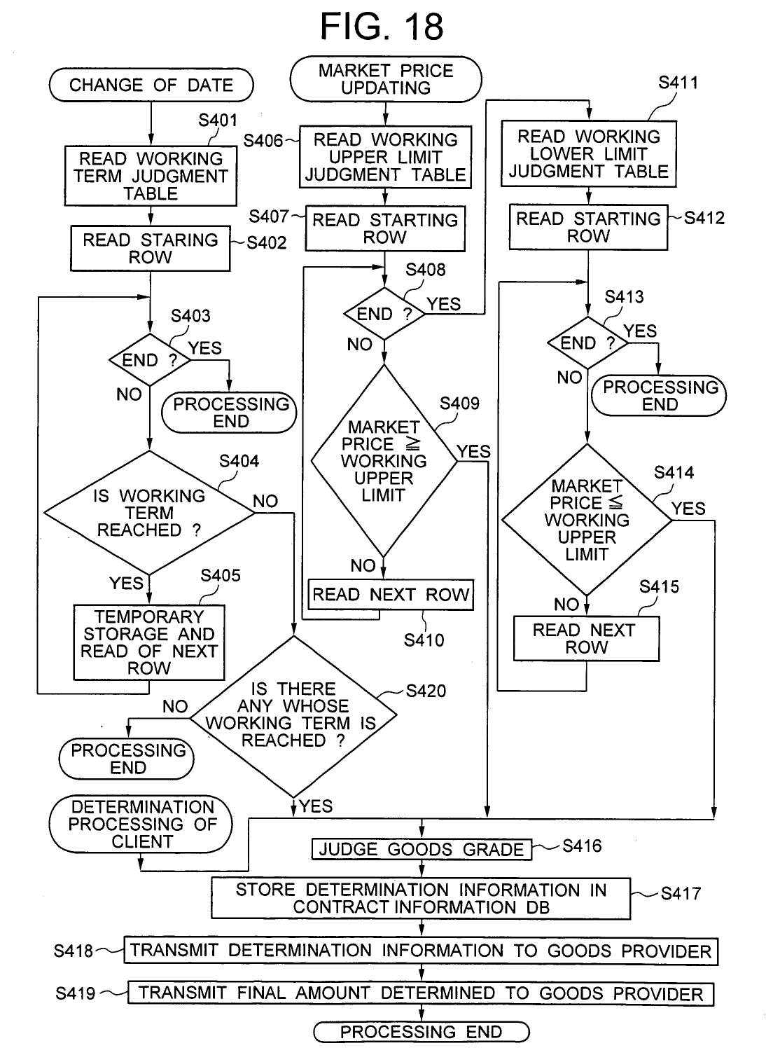

Next, the goods determination processing (processing 105) will be explained with reference to the flowchart shown in FIG. 18.

Determination of the goods takes place when any of the following conditions is satisfied. (1) When the client executes the determination processing on the working status confirmation screen in the working information confirmation process (processing 104) explained already. (2) When the working term is reached. (3) When the reference price of the financial products selected by the client exceeds the upper limit reference price (working lower limit price). (4) The reference price of the financial products selected by the client falls below the lower limit reference price (working lower limit price).

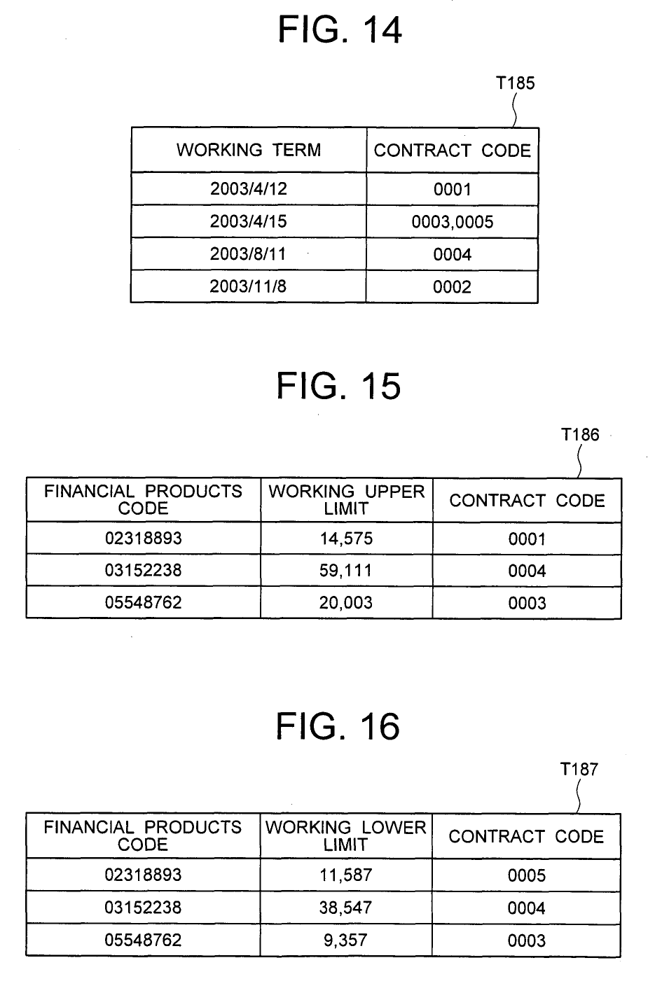

Among them, (1) is the procedure made by the client, and the goods determination judgment part 15 judges (2), (3) and (4). This judgment can be made quickly by use of the working term judgment table T185 shown in FIG. 14, the working upper limit judgment table T186 shown in FIG. 15 and the working lower limit judgment table T187 shown in FIG. 16. The working term judgment table T185 tabulates the working term in the sequence of the expiry date. These dates may be scanned from above when the date changes. When a record having a newer date appears, subsequent records need not be checked. The working upper limit judgment table T186 associates the working upper limit with the contract code for each financial products. When a plurality of clients selects the same financial products, the number of times of checks of judgment can be decreased when the working upper limit having the lowest amount is described. This also holds true of the working lower limit table T187.

The procedure for checking the arrival of the working term will be described in detail. First, the goods determination judgment part 15 reads the working term judgment table T185 (Step S401). Next, the goods determination judgment part 15 reads the leading row of the working term judgment table T185 (Step S402), compares the date with the working term (Step S404) when the leading row contains information (Step S403), temporarily stores the information and reads the next row (Step S405) when the working term is reached (Step S404). Similarly, the goods determination judgment part 15 repeats confirmation as to whether or not the working term is reached until no row exists any more (Step S420). When no row exists any more, the goods determination judgment part 15 confirms whether or not the row in which the working term is reached is stored temporarily (Step S420). When such exists, it means that the row in which the working term is reached exists. Similarly, the upper limit reference price and the lower limit reference price are checked, and the row in which the goods must be determined is extracted, if any.

When any goods to be determined exists, the goods determination judgment part 15 first acquires the market price information from the market price information DB 17, calculates the evaluation amount at the present reference price and judges to which goods grade this evaluation amount corresponds (Step S416). More concretely, the goods determination judgment part 15 acquires the reference price at the point at which the client enters the purchase of the goods (working starting-point) from the market price information DB 17, then acquires the reference price at the present point (working finish point) from the market price information DB 17, calculates the change ratio of the reference price at the working end point with respect to the reference price at the working starting point, and multiplies the purchase price of the goods by the change ratio to calculate the evaluation amount. It is preferred in this instance to subtract the sales tax involved in selling/purchasing of the financial products and the commission to be paid to the securities company from the evaluation amount. The goods determination judgment part 15 looks up the goods sub-table T192 and retrieves one or a plurality of grades below the evaluation amount. One or a plurality of grades so retrieved is the grade that the client can purchase. The goods determination judgment part 15 may well subtract the price of each grade from the evaluation amount for each grade below the evaluation amount to calculate the balance. Next, the determination information (inclusive of client information, identification information of determined goods, grade of determined goods and price of grade of determined goods) is stored in the contract information DB 18 (Step S417) and is transmitted to the client terminal 5 and to the goods provision company system 2 (Step S418). Subsequently, the service provision server 1 gives to the financial institution the payment instruction of the purchase amount corresponding to the price of the determined goods to the goods provision company (Step 419). In Step S416, the highest grade that the client can purchase may be decided as the grade of the goods the client is to purchase. Alternatively, the grade the client can purchase may be submitted to the client through the client terminal 5 and the grade the client selects from among the submitted grades of the goods may be decided as the goods of the grade the client is to purchase. In the latter case, the goods determination judgment part 15 displays the range of the purchasable grades by the amount of money the client obtains as a result of working of the investment to the client through the client terminal 5.

Besides the package tour described above, the invention can be applied to those goods or those services which have a time margin till delivery of the goods or services and to which a plurality of grades can be set, such as tickets (of airplanes, movies, etc), automobiles, apartment houses, and so forth.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A system for processing information on goods or services for extracting a goods or a service to be provided to a client from a goods or service group containing a plurality of goods or services having mutually different prices, comprising:
a goods information storage unit for storing explanation and a price of each goods or service contained in said goods or service group and explanation of financial products;
a market price storage unit for storing a market price of said financial products;
a contract information storage unit for storing a purchase goods or service group information for specifying said goods or service group said client enters for purchase, a purchase amount of said client for said goods or service group said client enters for purchase, selection financial products information determined for said goods or service group said client enters for purchase and a working term of said financial products determined for said goods or service group; and
a processing unit for calculating a post-working amount obtained as a result of investment of a fund corresponding to the purchase amount in said selection financial products when said working term is reached, and retrieving one or a plurality of goods or services purchasable by said post-working amount from the plurality of goods or services contained in said goods or service group of said goods information storage unit.

2. A system according to claim 1, wherein said processing unit calculates a change ratio of the market price of said financial products from the market price of said financial products at the point at which said client enters for purchase of the goods or service and from the market price of said financial products at the working term of said financial products when the working term is reached, multiplies the purchase amount by said change ratio to calculate a post-working amount, and retrieves one or a plurality of goods or services below said post-working amount from a plurality of goods or services contained in said goods or service group of said goods information storage unit.

3. A system according to claim 1, wherein said contract information storage unit stores a working lower limit price of said financial products, and said processing unit calculates, in place of said change ratio, a change ratio of the market price of said financial products from the market price of said financial products at the point at which said client enters purchase of the goods or service and from the market price of said financial products at the point at which the market price of said financial products reaches said working lower limit price.

4. A system according to claim 3, wherein said contract information storage unit stores a working upper limit price of said financial products, and said processing unit calculates in place of said change ratio a change ratio of a market price of said financial products from a market price of said financial products at the point at which said client enters purchase of a goods or service and from a market price of said financial products at the point at which the market price of said financial products reaches said working upper limit price.

5. A system according to claim 4, wherein said purchase goods or service group information contains purchase goods or service information for specifying an individual goods or service selected by said client from among said goods or service group, and said processing unit decides said working upper limit price on the basis of a price of a goods or service having the highest price among the goods or services contained in said purchase goods or service information and said working lower limit price on the basis of a price of a goods or service having the lowest price among the goods or services contained in said purchase goods or service information, and stores said working upper limit price and said working lower limit price in said contract information storage unit.

6. A system according to claim 4, wherein said processing unit decides said working upper limit price on the basis of a price of a goods or service having the highest price among the goods or services contained in said purchase goods or service information and said working lower limit price on the basis of a price of a goods or service having the lowest price among the goods or services contained in said purchase goods or service information, and stores said working upper limit price and said working lower limit price in said contract information storage unit.

7. A system according to claim 1, wherein said processing unit subtracts a predetermined period from a provision date of said goods or service to said client and stores said working term in said contract information storage unit.

8. A system according to claim 1, which further includes a communication unit capable of making communication with other systems and with a terminal of said client; said processing unit stores a market price of said financial products in said market price information storage unit; said communication unit receives an entry of purchase of said goods or service, said purchase goods or service information, said purchase amount and said selection financial products information from the terminal of said client; said processing unit stores an entry of purchase of said goods or service, said purchase goods or service information, said purchase amount and said selection financial products information from the terminal of said client in said contract information storage unit; and said communication unit transmits the purchase good or service information for specifying said one or plurality of goods or services retrieved to the terminal of said client.

9. A system for processing information on goods or services for providing goods or service information capable of being provided to a client from a goods or service group containing a plurality of goods or services having mutually different prices to said client, comprising:
a storage device for storing explanation and a price of each goods or service contained in said goods or service group, explanation of financial products in which a purchase fund of said goods or service is to be invested and working term of said financial products;
a goods information display unit for retrieving the explanation and the price of each goods or service and the explanation of said financial products from said storage device in response to a request from a terminal of said client and transmitting them to the terminal of said client;
a goods determination judgment unit for retrieving the working term of said financial products from said storage device by using identification information of a selected financial products as a key when receiving an entry of purchase of said goods or service group, a purchase amount of said goods or service and selection of said financial products from the terminal of said client;
a monitor unit for monitoring whether or not the working term of said financial products is reached; and
a goods determination acceptance unit for retrieving one or a plurality of goods or services purchasable by a post-working amount obtained as a result of investment of fund corresponding to said purchase amount in said financial products when said monitor unit judges that the working term of said financial products is reached, and transmitting information of said one or plurality of goods or services so retrieved as information of goods or services that can be provided to said client, to the terminal of said client.

10. A method for processing information on goods or services for providing goods or service information capable of being provided to a client from a goods or service group containing a plurality of goods or services having mutually different prices to said client, comprising the steps of:
storing in a storage device explanation and a price of each goods or service contained in said goods or service group, explanation of financial products in which a purchase fund of said goods or service is to be invested and a working term of said financial products;
retrieving the explanation and the price of each goods or service and the explanation of said financial products from said storage device in response to a request from a terminal of said client and transmitting them to the terminal of said client;
retrieving the working term of said financial products from said storage device by using identification information of a selected financial products as a key when receiving an entry of purchase of said goods or service group, a purchase amount of said goods or service and selection of said financial products from the terminal of said client;
monitoring whether or not the working term of said financial products is reached;
retrieving one or a plurality of goods or services purchasable by a post-working amount obtained as a result of investment of fund corresponding to said purchase amount in said financial products from a plurality of goods or services contained in said goods or service group of said storage device when said monitor unit judges that the working term of said financial products is reached; and
transmitting information of said one or plurality of goods or services so retrieved as information of goods or services that can be provided to said client, to the terminal of said client.

11. A method according to claim 10, further including the steps of:
calculating a change ratio of a market price of said financial products from a market price of said financial products at the point at which said client enters for purchase of said goods or service and from a market price of said financial products at the working term of said financial products when the working term is reached;
calculating said post-working amount by multiplying said purchase amount by said change ratio; and
retrieving one or a plurality of goods or services below the post-working amount from a plurality of goods or services contained in said goods or service group.

12. A method according to claim 10, further including the steps of:
storing a working lower limit price of said financial products in said storage device; and
calculating, in place of said change ratio, a change ratio of the market price of said financial products from a market price of said financial products at the point at which said client enters for purchase of said goods or service and from a market price of said financial products at the point at which the market price of said financial products reaches said working lower limit price.

13. A method according to claim 12, further including the steps of:
storing a working upper limit price of said financial products in said storage device; and
calculating, in place of said change ratio, a change ratio of a market price of said financial products from a market price of said financial products at the point at which said client enters for purchase of a goods or service and from a market price of said financial products at the point at which the market price of said financial products reaches said working upper limit price.

14. A method according to claim 13, further including the steps of:
causing said purchase good or service information to contain purchase goods or service information for specifying an individual goods or service selected by said client from among said goods or service group;
deciding said working upper limit price on the basis of a price of a goods or service having the highest price among the goods or services contained in said purchase goods or service information;
deciding said working lower limit price on the basis of a price of a goods or service having the lowest price among the goods or services contained in said purchase goods or service information; and storing said working upper limit price and said working lower limit price in said storage device.

15. A method according to claim 13, further including the steps of:
deciding said working upper limit price on the basis of a price of a goods or service having the highest price among the goods or services contained in said purchase goods or service information;
deciding said working lower limit price on the basis of a price of a goods or service having the lowest price among the goods or services contained in said purchase goods or service information; and
storing said working upper limit price and said working lower limit price in said storage device.

16. A method according to claim 10, further including the steps of:
subtracting a predetermined period from a provision date of said goods or service to said client; and
storing said working term in said storage device.

17. A method according to claim 10, further including the steps of:
receiving a market price of said financial products from said other system;
storing the market price of said financial products in said market price information storage unit;
receiving an entry of purchase of said goods or service, said purchase goods or service information, said purchase amount and said selection financial products information from the terminal of said client;
storing an entry of purchase of said goods or service, said purchase goods or service information, said purchase amount and said selection financial products information from the terminal of said client in said storage device; and
transmitting the purchase good or service information for specifying said one or plurality of goods or services retrieved to the terminal of said client.

18. A method for providing information on goods or services, for providing goods or service information capable of being provided to a client from a goods or service group containing a plurality of goods or services having mutually different prices to said client, comprising the steps of:
storing explanation and a price of each goods or service contained in said goods or service group, explanation of financial products in which a purchase fund of said goods or service is to be invested and a working term of said financial products;
retrieving the explanation and the price of each goods or service and the explanation of said financial products from said stoage device in response to a request from a terminal of said client;
transmitting the explanation and the price of each goods or service and the explanation of said financial products to the terminal of said client;
retrieving the working term of said financial products from said storage device by using identification information of a selected financial products as a key when receiving an entry of purchase of said goods or service group, a purchase amount of said goods or service and selection of said financial products from the terminal of said client;
monitoring whether or not the working term of said financial products is reached;
retrieving one or a plurality of goods or services purchasable by a post-working amount obtained as a result of investment of fund corresponding to said purchase amount in said financial products when said monitor unit judges that the working term of said financial products is reached; and
transmitting information of said one or plurality of goods or services so retrieved as information of goods or services that can be provided to said client, to the terminal of said client.

19. A method for providing information on goods or services, for providing goods or service information to which a plurality of grades is set, comprising the steps of:
accepting information of a goods or service a client desires to purchase from a terminal of said client;
accepting information of a financial products selected by said client from the terminal of said client;
associating a price of said financial products with the grade of said good or service;
deciding the grade of said goods or service depending on the price of said financial products after a predetermined time; and
transmitting information of said goods or service having the grade so decided to the terminal of said client.

20. A method according to claim 19, wherein said step of deciding the grade of said goods or service calculates an upper limit and a lower limit of the price of said financial products from a price corresponding to the grade selected by said client, and decides the grade of said goods at a timing at which the price reaches the upper limit and the lower limit through processing a unit.
